(19) United States
(12) Patent Application Publication
(10) Pub. No.: US 2022/0390933 A1
(43) Pub. Date: Dec. 8, 2022

(54) PATTERN RECOGNITION DEVICE

(71) Applicant: XIDAS, INC., Irvine, CA (US)

(72) Inventors: Mark Bachman, Irvine, CA (US); Philip N. Duncan, Irvine, CA (US)

(21) Appl. No.: 17/834,227

(22) Filed: Jun. 7, 2022

Related U.S. Application Data
(60) Provisional application No. 63/197,883, filed on Jun. 7, 2021.

(51) Int. Cl. G05B 23/02; G06N 20/00

(52) U.S. Cl. CPC G05B 23/0205; G06N 20/00

(57) ABSTRACT

The present invention is directed to a device capable of implementing a machine learning algorithm to identify states of operation, performance, and health of a piece of machinery based on vibration and sound patterns. The present invention features a small electronic device consisting of one or more sensors with a computing device, that collects patterns of vibration and/or acoustic measurement from machinery to generate one or more representative signals. The device uses a simple algorithm to characterize the representative signals, and uses a simple algorithm to compare future signals to the characterized signals.

### CROSS-REFERENCES TO RELATED APPLICATIONS

This application is a non-provisional and claims benefit of U.S. Provisional Application No. 63/197,883 filed Jun. 7, 2021, the specification of which is incorporated herein in its entirety by reference.

### FIELD OF THE INVENTION

The present invention is directed to a device capable of implementing a machine-learning algorithm to identify states of operation, performance, and health of a piece of machinery based on patterns of vibrations and sound.

### BACKGROUND OF THE INVENTION

There is a need for computing devices that can monitor and characterize one or more typical signals from vibrating machinery, to classify unknown signals at a future time. This approach is particularly important for machine monitoring and predictive maintenance applications where one wishes to determine whether a machine's characteristic signal is no longer normal or trending towards a known failure mode. By continuously monitoring vibration or sound from machinery, characterizing the signal, and comparing it to known characteristic signals for states of operation, one can determine the health, performance, and operation mode of the machinery.

Characterization and classification of signals involve two steps. The first step is “learning” (often called “machine learning”) where the signal pattern must be “learned” by a computer. In this stage, many signal measurements, taken from known performance and operation mode, are presented to a computer which then “learns” the signal. The process of directing the learning is referred to as “training” and the signal measurements are referred to as “training data”. The result of this machine learning is a “model”, which is a mathematical representation, embodied in computer-executable instructions, of the typical signal for a given state.

The second step is “classification”. In this step, one or more models are compared to an unknown signal and an algorithm is used to determine the “best match”. The match quality is usually presented as a single number or score. This process of using classification or other results from the model is referred to as “inference”. Using machine learning and inference, a computer may be able to accurately characterize the health, performance, and operational state of machinery.

Modern machine learning and inference typically use models based on neural networks. Neural networks are popular because they can produce models for a wide array of signal types, without a priori understanding of the signal characteristics in advance. The neural network model is specified by a list of coefficients that represents weights at each node in the neural network. These coefficients have almost no understandable significance to the physical signal but serve to drive the model towards a classification of an input signal.

Machine learning and inference with neural networks have been very successful in solving many difficult signal recognition problems (such as facial recognition, voice recognition, etc.). However, generating the model (training) is very computationally expensive, requiring large amounts of computing power to find the optimal coefficients for the training data. Furthermore, typical neural network models have large numbers of coefficients, often ranging from hundreds to thousands of coefficients.

There is a need to put signal recognition in small computing devices that can be placed on machinery that need to be monitored and classified, but without requiring telemetry of large data sets to external servers (for cloud computing), or high processing capabilities. Neural network pattern recognition is sometimes used for these low-resource applications; some neural network software has been placed in microcontrollers, for example. However, these applications of neural network devices still require large amounts of processing to train the models. Usually, this learning stage is performed by collecting large amounts of data from machinery, then sending the data to the cloud for processing by multiple computers. After training, the final model coefficients are then loaded onto the small processor which can perform classifications during normal operation.

There would be great utility in a method for building a model representation of a vibration or acoustic signal which uses a small number of coefficients and that can be trained without the need for complex calculations. The underlying model need not be as general-purpose as a neural network based model, as long as it works well for characterizing machinery from vibration and/or acoustics. Such a model system, with training and classification, could be placed in small computing devices such as microcontrollers, to monitor machinery in the field without the need to connect to external computers in the cloud.

### BRIEF SUMMARY OF THE INVENTION

It is an objective of the present invention to provide systems and methods that allow for implementing a machine-learning algorithm to identify states of operation, performance, and health of a piece of machinery based on patterns of vibrations and sound, as specified in the independent claims. Embodiments of the invention are given in the dependent claims. Embodiments of the present invention can be freely combined if they are not mutually exclusive.

This invention describes a computing device intended to be used to monitor and characterize patterns of vibrations and/or sound from machinery to identify states of operation and performance and/or health of the machinery. The invention consists of a small electronic device containing at least one computing device and one or more sensors capable of monitoring patterns of vibration and/or sound. The computing device collects data from the sensors to generate one or more representative signals, each signal being described as a relationship between frequency and amplitude. The processor uses a simple algorithm to generate one or more models that characterize the representative signals, each model being represented as a list of coefficients that describe mathematical quantities in selected regions of the signal. The region selection is optimized to give the best model. The models' coefficients are stored in processor memory, and may also be stored in memory not connected to the device, such as in the cloud. At a future time, the processor uses a similar algorithm to calculate the region coefficients for an arbitrary signal and uses these coefficients to determine the quality of match with the different models in memory.

The present invention features a system for identifying states of operation of machinery through the use of signal classification and comparison. In some embodiments, the system may comprise one or more sensors. Each sensor may be capable of measuring a signal pattern of the machinery in contact with the sensor. The system may further comprise a computing device capable of executing the plurality of computer-executable instructions. The computer-executable instructions may comprise receiving a plurality of characteristic signals from the one or more sensors. Each characteristic signal may represent a known state of operation of the machinery. The computer-executable instructions may further comprise separating each characteristic signal of the plurality of characteristic signals into one or more regions. The computer-executable instructions may further comprise generating, based on the one or more regions of each characteristic signal, one or more mathematical models, receiving a new signal from the one or more sensors, comparing the new signal to the one or more mathematical models, and classifying the new signal based on the comparison between the new signal and the one or more mathematical models.

The present invention features a method for identifying states of operation of machinery through the use of signal classification and comparison. In some embodiments, the method may comprise providing one or more sensors. Each sensor may be capable of measuring a signal pattern of the machinery in contact with the sensor. The method may further comprise providing a computing device. The method may further comprise receiving a plurality of characteristic signals from the one or more sensors. Each characteristic signal may represent a known state of operation of the machinery. The method may further comprise separating each characteristic signal of the plurality of characteristic signals into one or more regions. The method may further comprise generating, based on the one or more regions of each characteristic signal, one or more mathematical models. The method may further comprise receiving a new signal from the one or more sensors, comparing the new signal to the one or more mathematical models, and classifying the new signal based on the comparison between the new signal and the one or more mathematical models.

One of the unique and inventive technical features of the present invention is the use of a simple algorithm in a computing device that can be used to characterize a pattern in a vibration or audio signal using a simple list of coefficients. Without wishing to limit the invention to any theory or mechanism, it is believed that the technical feature of the present invention advantageously provides for quickly optimized model parameters. The algorithm breaks the signal into a variable number of regions in the abscissa and varies the region widths and locations to maximize the structure seen in the ordinate. None of the presently known prior references or work has the unique inventive technical feature of the present invention.

Any feature or combination of features described herein are included within the scope of the present invention provided that the features included in any such combination are not mutually inconsistent as will be apparent from the context, this specification, and the knowledge of one of ordinary skills in the art. Additional advantages and aspects of the present invention are apparent in the following detailed description and claims.

### BRIEF DESCRIPTION OF THE SEVERAL VIEWS OF THE DRAWING(S)

The features and advantages of the present invention will become apparent from a consideration of the following detailed description presented in connection with the accompanying drawings in which:

FIG. 1A shows an illustration of a typical device of the present invention with sensors used to monitor machinery.

FIG. 1B shows the illustration of the typical device of the present invention with sensors used to monitor machinery with a frequency-amplitude readout produced by the said device.

FIG. 2 shows a flow chart of a method of identifying states of operation of a machinery through use of signal classification and comparison.

FIG. 3 shows an illustration of a typical signal, presented as a relationship between frequency and amplitude that represents a condition of a piece of machinery.

FIG. 4 shows how the signal is subdivided into a variable number of regions with variable widths, the region shapes being determined by the structure of the signal.

FIG. 5 shows how the signal is subdivided into a variable number of regions with variable widths, the region shapes being determined by the structure of the signal.

FIG. 6 shows a new signal coming from a machinery in an unknown state, compared to the coefficients from a model that was previously calculated.

FIG. 7 shows a representative signal and how two-dimensional regions may be used to characterize the signal.

### DETAILED DESCRIPTION OF THE INVENTION

Following is a list of elements corresponding to a particular element referred to herein:

101 pattern recognition device

103 machinery

105 vibration

107 sound

201 abscissa axis

203 ordinate axis

301 signal

303 plurality of regions

305 lower bound

307 upper bound

309 representative quantities

311 model

401 plurality of signals

403 initial non-optimized values

405 slope

407 range

409 variance

411 low structure

413 specific operation model

501 new signal

503 existing model

601 representative signal

603 two-dimensional regions

700 computing device

701 communication component

702 memory component

703 processor

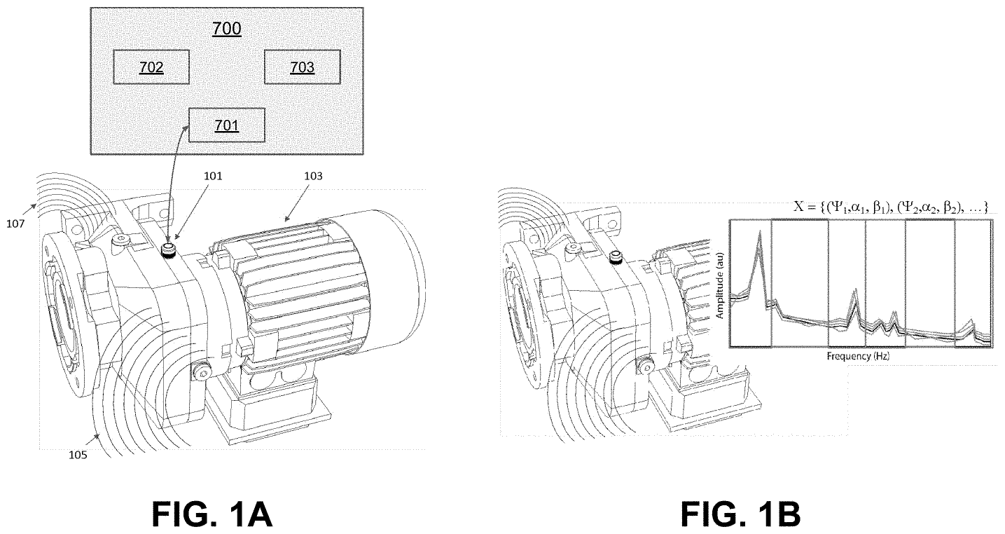

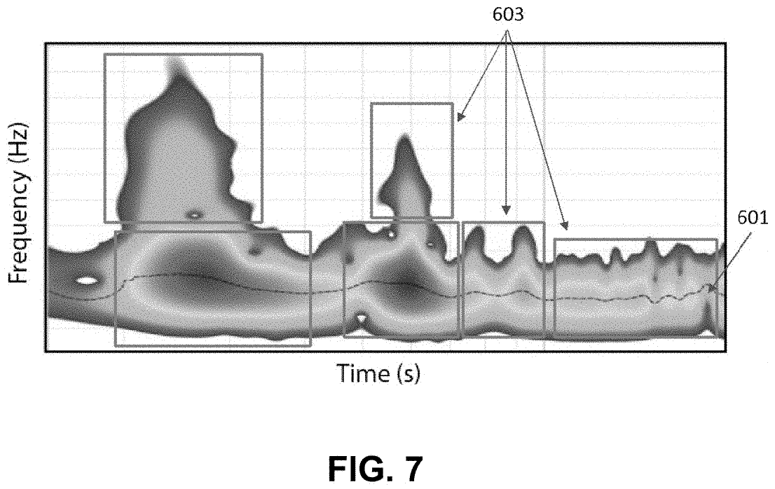

Referring now to FIGS. 1A-7, the present invention features a system for identifying states of operation of a machinery (103) through use of signal classification and comparison. In some embodiments, the system may comprise one or more sensors. Each sensor (101) may be capable of measuring a signal pattern of the machinery (103) in contact with the sensor. The system may further comprise a computing device (700) comprising a communication component (701) communicatively coupled to the one or more sensors, a memory component (702) comprising a plurality of computer-executable instructions, and a processor (703) capable of executing the plurality of computer-executable instructions. In some embodiments, the computer-executable instructions may comprise receiving a plurality of characteristic signals from the one or more sensors. Each characteristic signal may represent a known state of operation of the machinery (103). The computer-executable instructions may further comprise separating each characteristic signal of the plurality of characteristic signals into one or more regions. A number of regions, a lower bound of each region, and an upper bound of each region may be determined by a mathematical algorithm. The computer-executable instructions may further comprise generating, based on the one or more regions of each characteristic signal, one or more mathematical models, receiving a new signal from the one or more sensors, comparing the new signal to the one or more mathematical models, and classifying the new signal based on the comparison between the new signal and the one or more mathematical models.

In some embodiments, the mathematical algorithm may determine the upper bound and the lower bound based on minimizing or maximizing, respectively, a measured quantity in a signal. In some embodiments, the measured quantity may be selected from a group comprising a slope, an average value, a standard deviation, a maximum value, coefficients of a regression analysis in that region, and a combination thereof. In some embodiments, the mathematical algorithm may calculate one or more representative quantities based on a signal form in each region. In some embodiments, the upper bound, the lower bound, and the one or more representative quantities per region may form a set of coefficients that characterize a corresponding signal. The set of coefficients may be stored in the memory component. In some embodiments, the plurality of computer-executable instructions may further comprise separating the new signal into one or more regions. A number of regions, a lower bound of each region, and an upper bound of each region may be determined by the mathematical algorithm. The computer-executable instructions may further comprise calculating one or more representative quantities based on a signal form in each region. The one or more representative quantities may be compared to the one or more mathematical models. In some embodiments, the one or more regions may be one-dimensional regions, two-dimensional regions, or N-dimensional regions.

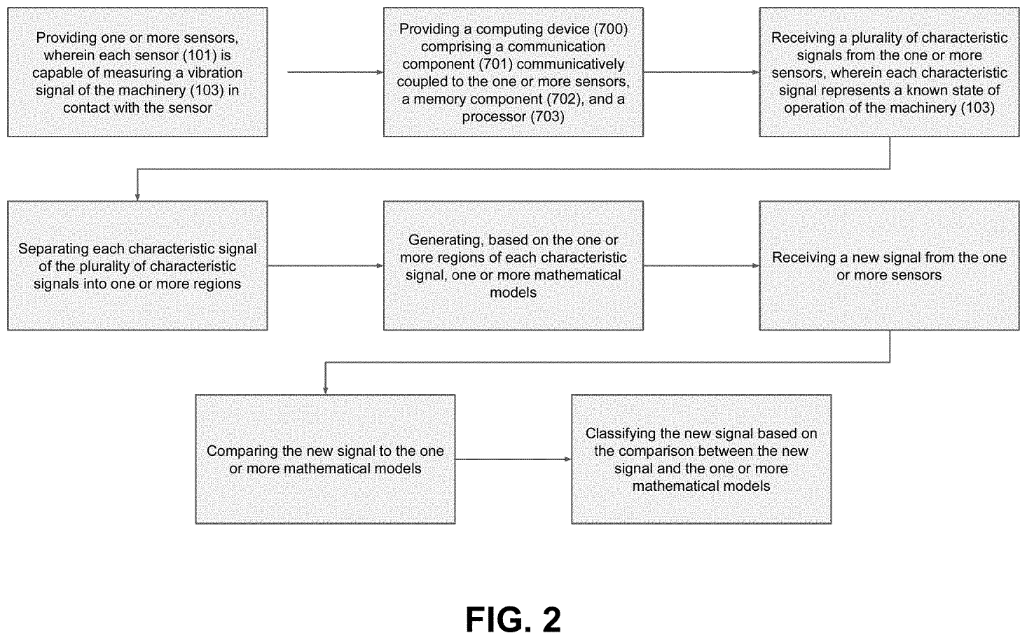

Referring now to FIG. 2, the present invention features a method for identifying states of operation of a machinery (103) through use of signal classification and comparison. In some embodiments, the method may comprise providing one or more sensors. Each sensor (101) may be capable of measuring a signal pattern of the machinery (103) in contact with the sensor. The method may further comprise providing a computing device (700) comprising a communication component (701) communicatively coupled to the one or more sensors, a memory component (702), and a processor (703). The method may further comprise receiving a plurality of characteristic signals from the one or more sensors. Each characteristic signal may represent a known state of operation of the machinery (103). The method may further comprise separating each characteristic signal of the plurality of characteristic signals into one or more regions. A number of regions, a lower bound of each region, and an upper bound of each region may be determined by a mathematical algorithm. The method may further comprise generating, based on the one or more regions of each characteristic signal, one or more mathematical models. The method may further comprise receiving a new signal from the one or more sensors, comparing the new signal to the one or more mathematical models, and classifying the new signal based on the comparison between the new signal and the one or more mathematical models.

In some embodiments, the mathematical algorithm may determine the upper bound and the lower bound based on minimizing or maximizing, respectively, a measured quantity in a signal. In some embodiments, the measured quantity may be selected from a group comprising a slope, an average value, a standard deviation, a maximum value, coefficients of a regression analysis in that region, and a combination thereof. In some embodiments, the mathematical algorithm may calculate one or more representative quantities based on a signal form in each region. In some embodiments, the upper bound, the lower bound, and the one or more representative quantities per region may form a set of coefficients that characterize a corresponding signal. The set of coefficients may be stored in the memory component. In some embodiments, the method may further comprise separating the new signal into one or more regions. A number of regions, a lower bound of each region, and an upper bound of each region may be determined by the mathematical algorithm. The method may further comprise calculating one or more representative quantities based on a signal form in each region. The one or more representative quantities may be compared to the one or more mathematical models. In some embodiments, the one or more regions may be one-dimensional regions, two-dimensional regions, or N-dimensional regions.

This invention describes a small computing device and one or more sensors used to monitor a piece of machinery. FIG. 1A is an overview of the device (101) connected to a piece of machinery (103). The device has sensors that can monitor patterns in vibration (105) and/or sound (107). Information from these sensors is used to classify the state of the machinery, which can be used to ensure that the machinery is operating as expected.

The device collects data from one or more sensors that monitor the machinery's pattern of vibration and/or sound to form a signal, the signal being represented by a relationship between the frequency and amplitude of the vibrations or sound. Kinds of signals that may be measured include but are not limited to acoustic (sound), vibration, light, temperature, and magnetic field signals. These signals may be in the time, frequency, or other derived domain. FIG. 2 shows a typical signal from a vibrating piece of machinery, with the frequency of vibration shown on the abscissa axis [201] and the amplitude of vibration shown on the ordinate axis [203]. During operation, the device calculates coefficients of a model intended to represent this signal, then compares these measured coefficients to a list of pre-calculated coefficients for different operating conditions of the machinery. The quality of the match between the pre-calculated coefficients and the measured coefficients is used to classify the nature of the machinery operation.

To create the pre-calculated coefficients, a procedure is taken to perform multiple measurements of the machinery in known states of operation and known performance. Examples of states include normal operation, stalled, stopped, turned off, paused, needing maintenance of various types (lubrication, part replacement), etc. During this procedure, known as “training,” the machinery is put into a known state of operation with known performance. Multiple measurements are made by the device and stored in memory. Multiple characteristic signals are generated from the measurement data. These characteristic signals for the machinery's known operating condition, form a “training set” for creating the model that represents this machine's operating condition.

This invention utilizes an efficient algorithm to model this signal that requires relatively low computing resources compared with neural network models, thus allowing the “training” to be performed on the device itself without the need for uploading data to an external computer. The method for building the models' pre-calculated coefficients is described herein.

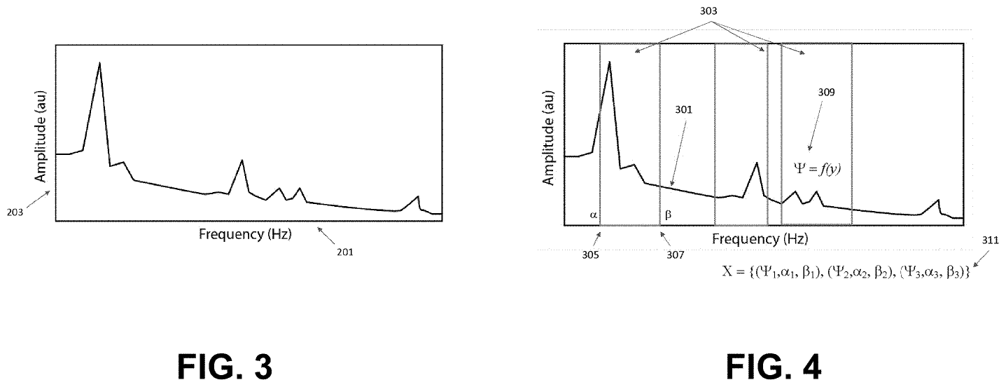

FIG. 3 shows a typical signal (301) from a vibrating piece of machinery, with the signal split into multiple regions (303). Each region is defined by the lower bound (305) and upper bound (307) of the region. Within each region, one or more representative quantities (309) can be calculated for the signal that falls within the region, each representing a structural feature of the signal in that region. Examples of representative quantities include, but are not limited to, average, maximum, minimum, range, mode, median, variance, slope, concavity, or coefficients of a regression analysis in that region. These quantities may be calculated using all of the data within a region, or a subset of the data within a region. The list of region boundaries and representative quantities forms the coefficient set for the model (311). The device calculates this coefficient set for the signal when characterizing the signal.

During training, the device utilizes an optimization procedure to determine the best model coefficients to represent the training signals. In this procedure, multiple training sets of signals are provided to the computing device, which represents typical conditions for a state of operation of the machinery. FIG. 4 shows an overlay of multiple signals (401) for a given state of operation. The optimization algorithm first splits the signal into N regions, where N>1. Each region's boundaries are determined by some initial non-optimized values, typically non-overlapping (403). Within each region, a quantity is calculated that represents the signal's “structure” within the region. “Structure” refers to how strongly the signal changes within a region, and may be represented by a variety of quantities, including (but not limited to) range, maximum, and slope. FIG. 4 depicts two examples of regions that have high structure, where the structure is defined by the slope (405), or by range (407), or by variance (409) or other relevant moments. Also shown are regions that have low structure (411). An overall structure score is determined based on the individual structure quantities calculated for each region. The algorithm then varies the region boundaries to maximize the overall structure score. If applicable, the algorithm may repeat this procedure for different numbers of regions (N). Once the optimal regions have been determined, each region's representative quantities are calculated for each training signal. A final representative quantity per region is determined by a weighted average for the representative quantities in each region. In addition, a weight per region is also calculated which may depend on the variance of the weighted average, as well as other factors such as the structure and size of the region. Together, the optimized region boundaries, representative quantities, and weights form the model coefficients for this specific operation mode (413).

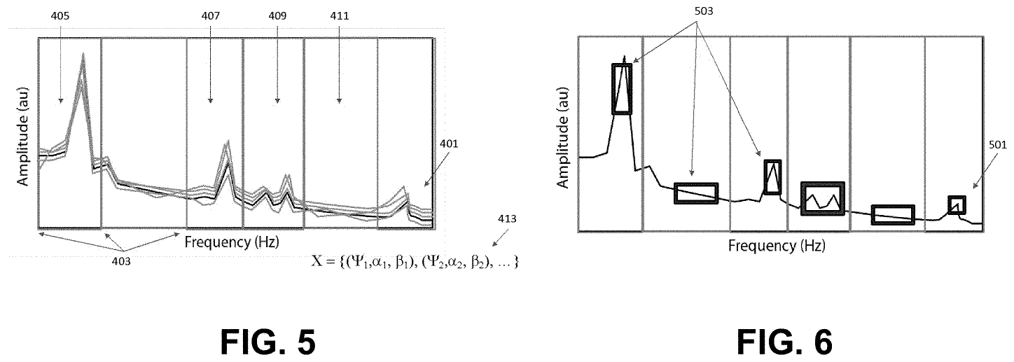

During operation, the coefficients for each model are stored in memory (either in the device or in an external storage device). These represent different states of operation of the machinery. FIG. 5 shows a new signal (501), coming from a machinery in an unknown state, compared to the coefficients from a model that was previously calculated (503). A total score is calculated based on how closely the signal coefficients of the new signal match the coefficients of the model that was previously calculated. This score is used to determine the classification of the state of operation of the machinery.

This method may be extended to patterns of vibration and acoustic signatures that have more complex regions. FIG. 6 shows a representative signal (601) and how two-dimensional regions (603) may be used to characterize the signal.

Although there has been shown and described the preferred embodiment of the present invention, it will be readily apparent to those skilled in the art that modifications may be made thereto which do not exceed the scope of the appended claims. Therefore, the scope of the invention is only to be limited by the following claims. In some embodiments, the figures presented in this patent application are drawn to scale, including the angles, ratios of dimensions, etc. In some embodiments, the figures are representative only and the claims are not limited by the dimensions of the figures. In some embodiments, descriptions of the inventions described herein using the phrase “comprising” includes embodiments that could be described as “consisting essentially of” or “consisting of”, and as such the written description requirement for claiming one or more embodiments of the present invention using the phrase “consisting essentially of” or “consisting of” is met.

The reference numbers recited in the below claims are solely for ease of examination of this patent application, and are exemplary, and are not intended in any way to limit the scope of the claims to the particular features having the corresponding reference numbers in the drawings.

What is claimed is:

1. A system for identifying states of operation of a machinery (103) through use of signal classification and comparison, the system comprising:
a. one or more sensors, wherein each sensor (101) is capable of measuring a signal pattern of the machinery (103) in contact with the sensor; and
b. a computing device (700) communicatively coupled to the one or more sensors, a memory component (702) comprising a plurality of computer-executable instructions, and a processor (703) capable of executing the plurality of computer-executable instructions, the computer-executable instructions comprising:
i. receiving a plurality of characteristic signals from the one or more sensors, wherein each characteristic signal represents a known state of operation of the machinery (103);
ii. separating each characteristic signal of the plurality of characteristic signals into one or more regions;
iii. generating, based on the one or more regions of each characteristic signal, one or more mathematical models;
iv. receiving a new signal from the one or more sensors;
v. comparing the new signal to the one or more mathematical models; and
vi. classifying the new signal based on the comparison between the new signal and the one or more mathematical models.

2. The system of claim 1, wherein a number of regions, a lower bound of each region, and an upper bound of each region are determined by a mathematical algorithm, wherein the mathematical algorithm calculates one or more representative quantities based on a signal form in each region.

3. The system of claim 2, wherein the mathematical algorithm determines the upper bound and the lower bound based on minimizing or maximizing, respectively, a measured quantity in a signal.

4. The system of claim 3, wherein the measured quantity is selected from a group comprising a slope, an average value, a standard deviation, a maximum value, coefficients of a regression analysis, and a combination thereof.

5. The system of claim 2, wherein the upper bound, the lower bound, and the one or more representative quantities per region form a set of coefficients that characterize a corresponding signal.

6. The system of claim 5, wherein the set of coefficients are stored in the memory component.

7. The system of claim 1, wherein the plurality of computer-executable instructions further comprises:
a. separating the new signal into one or more regions, wherein a number of regions, a lower bound of each region, and an upper bound of each region are determined by the mathematical algorithm; and
b. calculating one or more representative quantities based on a signal form in each region, wherein the one or more representative quantities are compared to the one or more mathematical models.

8. The system of claim 1, wherein the one or more regions are one-dimensional regions.

9. The system of claim 1, wherein the one or more regions are two-dimensional regions.

10. The system of claim 1, wherein the one or more regions are N-dimensional regions.

11. A method for identifying states of operation of a machinery (103) through use of signal classification and comparison, the method comprising:
a. providing one or more sensors, wherein each sensor (101) is capable of measuring a signal pattern of the machinery (103) in contact with the sensor; and
b. providing a computing device (700) communicatively coupled to the one or more sensors;
c. receiving a plurality of characteristic signals from the one or more sensors, wherein each characteristic signal represents a known state of operation of the machinery (103);
d. separating each characteristic signal of the plurality of characteristic signals into one or more regions;
e. generating, based on the one or more regions of each characteristic signal, one or more mathematical models;
f. receiving a new signal from the one or more sensors;
g. comparing the new signal to the one or more mathematical models; and
h. classifying the new signal based on the comparison between the new signal and the one or more mathematical models.

12. The method of claim 11, wherein a number of regions, a lower bound of each region, and an upper bound of each region are determined by a mathematical algorithm, wherein the mathematical algorithm determines the upper bound and the lower bound based on minimizing or maximizing, respectively, a measured quantity in a signal.

13. The method of claim 12, wherein the measured quantity is selected from a group comprising a slope, an average value, a standard deviation, a maximum value, coefficients of a regression analysis, and a combination thereof.

14. The method of claim 11, wherein the mathematical algorithm calculates one or more representative quantities based on a signal form in each region.

15. The method of claim 14, wherein the upper bound, the lower bound, and the one or more representative quantities per region form a set of coefficients that characterize a corresponding signal.

16. The method of claim 15, wherein the set of coefficients are stored in the memory component.

17. The method of claim 11, wherein the plurality of computer-executable instructions further comprises:
a. separating the new signal into one or more regions, wherein a number of regions, a lower bound of each region, and an upper bound of each region are determined by the mathematical algorithm; and
b. calculating one or more representative quantities based on a signal form in each region, wherein the one or more representative quantities are compared to the one or more mathematical models.

18. The method of claim 11, wherein the one or more regions are one-dimensional regions.

19. The method of claim 11, wherein the one or more regions are two-dimensional regions.

20. The method of claim 11, wherein the one or more regions are N-dimensional regions.
